(19) United States
(12) Patent Application Publication
(10) Pub. No.: US 2008/0031277 A1
(43) Pub. Date: Feb. 7, 2008

(54) Methods and apparatus to determine communication carrier capabilities

(76) Inventors: Edward Walter, Boerne, TX (US); Michael Raftelis, San Antonio, TX (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/499,112

(22) Filed: Aug. 4, 2006

(51) Int. Cl. H04J 3/16

(52) U.S. Cl. 370/469

(57) ABSTRACT

Methods and apparatus are disclosed to enable a service provider to determine capabilities of a communication carrier. An example method disclosed herein includes transmitting a metric information request to at least one of a layer two open standards interconnect (OSI) device or a layer three OSI device, the at least one layer two or layer three OSI device storing metric information indicative of carrier capabilities, and the example method receives the metric information from the at least one layer two or layer three OSI device.

### FIELD OF THE DISCLOSURE

This disclosure relates generally to communication carrier selection, and, more particularly, to methods and apparatus to determine communication carrier capabilities.

### BACKGROUND

Service providers may offer a wide variety of communication services to subscribers, such as plain old telephone services, voice-over-internet protocol (VoIP) services, Internet connectivity services, and/or broadcast programming services, such as television and/or audio services. Some service providers own, maintain, and upgrade some or all of their own communication networks to provide various services to their subscriber base. The communication networks typically include a vast array of geographically distributed copper cable, fiber-optic cable, routers, switches, servers, repeaters, signal control points (SCPs), signal switching points (SSPs), databases, and/or digital pair gain (DPG) devices, to name a few examples. Accordingly, if the service provider that owns such a communication network(s) identifies performance issues and/or outages, capital investments may be applied to the network infrastructure to facilitate various remedies and/or improvements.

Other service providers may not own, maintain, and/or control all of a communication network to enable various communication services to their subscribers. These service providers may instead contract with third party communication carriers, which are capable of accommodating the communication needs of any particular subscriber base.

The needs of different subscriber groups may vary considerably. For instance, a first example subscriber group may require basic communication needs that include moderate bandwidth capabilities and a relatively high tolerance to occasional network interruptions. Another subscriber group may be much more demanding with respect to network performance and require sophisticated communication services that rely upon high bandwidth capabilities and have a relatively low tolerance to any network interruptions and/or outages.

To service the needs of these different subscriber groups, a service provider may choose between communication carriers to deliver services to their subscribers. These choices may involve tedious inquiries to a large number of communication carriers before a suitable carrier candidate can be found. The service provider may need to know specific details regarding price, jitter characteristics, and/or protective subsystem capabilities to reduce negative effects of communication path downtime. Additionally, the service provider may need to know various capabilities for specific times during the day and/or week. To obtain such information, the service provider may be required to obtain special access permission to the various communication carrier candidates, and/or to rely upon published performance metrics, which may not reflect current capabilities of the carrier.

### BRIEF DESCRIPTION OF THE DRAWINGS

FIG. 1 is a schematic diagram illustrating an example system to determine communication carrier capabilities.

FIG. 2 is a more detailed illustration of the example path acceptance criteria manager of FIG. 1.

FIG. 3 is a portion of an example profile table of the example system of FIG. 1.

FIGS. 4A-4E are example metric tables of the example system of FIG. 1.

FIG. 5 is an example graphical user interface (GUI) for the example system of FIG. 1.

FIGS. 6-8 are flow diagrams representative of example machine readable instructions which may be executed to implement the example system of FIG. 1.

FIG. 9 is a schematic illustration of an example computer that may execute the processes of FIGS. 6-8 to implement the example system of FIG. 1.

### DETAILED DESCRIPTION

Methods and apparatus are disclosed to enable a service provider to determine capabilities of a communication carrier. An example method disclosed herein includes transmitting a metric information request to at least one of a layer two open standards interconnect (OSI) device or a layer three OSI device, at least one layer two or layer three OSI device storing metric information indicative of carrier capabilities, and the example method receives the metric information from the at least one layer two or layer three OSI device.

A service provider may make a selection of a communication carrier based on any number of criteria, referred herein as path acceptance criteria (PAC). For example, the service provider may have particular needs with respect to PAC including, but not limited to, carrier performance, carrier protection mechanisms/procedures, the carrier's time-of-day (TOD) bandwidth capabilities, a carrier preference, and/or the price the carrier may charge for its services to the service provider.

Performance capabilities of the carrier may include metrics related to jitter, latency, and/or packet loss. Various applications that service providers offer their subscribers may be very susceptible to changes in the transmission characteristics of data networks, particularly applications involving voice and/or video transmission. Voice over internet protocol (VoIP) is one such application that may be susceptible to noticeable degradation due to latency characteristics of the communication carrier's infrastructure. Excessive latency may degrade the voice application to a point that bothers and/or inconveniences the average VoIP subscriber. For example, delays in excess of approximately 150 milliseconds (mS) typically render a VoIP application unacceptable. Similarly, variation of delay over time, referred to as jitter, may also render a VoIP application unacceptable, for example, if such variations are too wide. While a jitter buffer may normalize such variations to improve the voice quality of a VoIP call, some carriers' jitter buffer depths may be too low for very discriminating subscribers.

The protection capabilities of the carrier represent a survivability aspect of the carrier's network during failure events. Failure events may include fiber cuts, equipment failures, facility failures, lightening strikes, etc. While a communication carrier may have many communication paths to service geographically distributed regions, a failure event may render one or more paths inoperable. Path outage times (downtime) vary depending on the network architecture implemented by the communication carrier. For instance, a path protected by a SONET ring, such as a unidirectional path switched ring (UPSR) or a bi-directional line switched ring (BLSR), typically restores path functionality in less than 50 mS. Other types of SONET protection mechanisms include, but are not limited to, 1:N or 1+1 automatic protection switching (APS) systems. The former employs a single protection mechanism for each of N working facilities, thereby allowing the value of N to be scaled to meet the desired risk tolerances of a network. 1+1 APS mechanisms, on the other hand, employ a dedicated protection facility for every working facility, thereby reducing path outage times more drastically than a 1:N architecture. Protection architectures having fast restoration and/or redirection times typically cost more to implement and maintain, resulting in higher costs to the end user.

Protection capabilities may also contemplate multi protocol label switching (MPLS) based recovery architectures, sometimes referred to as “fast reroute.” MPLS protection architectures may be configured as one-to-one backup methods or facility backup methods. The one-to-one backup method creates detour label switch paths (LSPs) for each protected LSP at each potential point of repair. Typically, the one-to-one backup method attempts to utilize an original path tunnel as much as possible, with needed bypasses made around the failure point (e.g., a failed switch, hub, central office, etc.). Each device (e.g., router) along the original path tunnel is configured with possible bypass routes in the event of a failure. The facility backup method, on the other hand, diverts network traffic away from failure points and typically takes a completely different path tunnel.

Additionally, protection capabilities may include resilient packet ring (RPR) architectures, which result in outage recovery times that vary as a function of network traffic. For example, if the sum total of the working traffic is equal to or less than half of the total bandwidth of a ring, then the outage times during a failure may be equivalent to those utilizing a SONET architecture (e.g., less than approximately 50 mS). However, if the bandwidth is oversubscribed, then the outage times may vary, thereby reducing predictability and reliability for end users.

Time of day capabilities of the carrier reflect varying bandwidth consumption at various times of the day, and/or days of the week. Such criteria may allow a service provider to avoid usage of a particular communication carrier at certain times when carrier bandwidth is heavily consumed.

Carrier preference may be a factor considered by a service provider based on previous experience with a communication carrier, customer service response time and/or politeness, recommendations, personal preferences, and/or a general rapport between the service provider and the communication carrier. The service provider may exploit the use of preferred communication carriers, when available, and use various non-preferred carriers as backup paths when failures occur.

Service providers may select various communication carriers based on price, particularly when the service provider's end-users exhibit cost judicious behavior. On the other hand, communication carrier price characteristics for the use of communication networks/paths may be less important to end-users that demand performance to a greater degree than economy. In some situations, price is not a factor due to federal, state, and/or municipal regulations, such as those that require 911 emergency services to the service provider's end users.

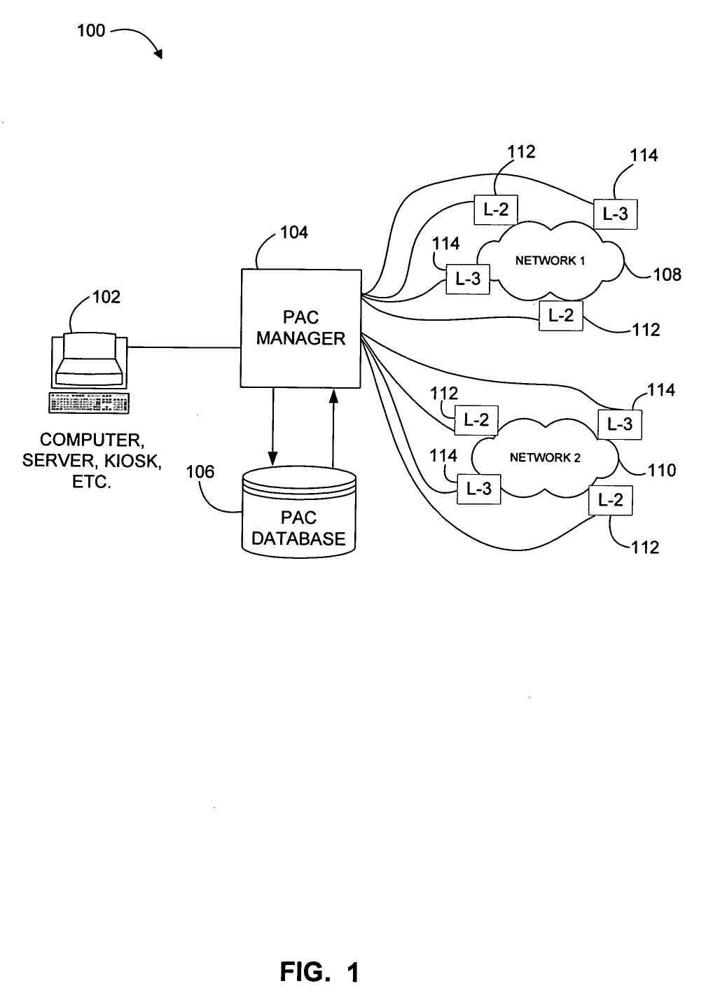

An example path acceptance criteria (PAC) analysis system 100 is shown in FIG. 1. A service provider and/or other entity interested in communication carrier performance analysis utilizes an access device 102 (e.g., a computer, a server, a kiosk, a touch-tone voice system, etc.) to access a PAC manager 104. As discussed in further detail below, the PAC manager 104 may provide a graphical user interface (GUI) for the service provider to facilitate various queries of communication carrier capabilities. A PAC database 106 is communicatively connected to the PAC manager 104 to store carrier capability information, network capability information, profiles containing metric preferences, and/or service provider criteria metrics to help select an appropriate communication carrier for the service provider's needs.

The PAC manager 104 may be operatively connected to any private or public network, such as the Internet. Generally speaking, a network implemented by a communication carrier reflects some or all of an open systems interconnection (OSI) reference model. The OSI model is a layered abstract description for communications in a network. The OSI model contains seven layers. Various layers are also known as a stack, in which protocol stacks may be implemented in hardware, software, or a combination of both hardware and software. Each layer adheres to industry accepted standards and/or protocols, thereby allowing interoperability between devices and/or networks of unrelated manufacturers and/or communication carriers. The OSI layers include a physical layer (layer 1), a data link layer (layer 2), a network layer (layer 3), a transport layer (layer 4), a session layer (layer 5), a presentation layer (layer 6), and an application layer (layer 7). In the illustrated example, the PAC manager 104 interacts with one or more layer 2 and/or layer 3 devices of a communication carrier's network to collect PAC information.

Layer 2, the data link layer, provides functional and procedural processes to transfer data between network entities. Persons of ordinary skill in the art will appreciate that layer 2 devices include, but are not limited to, network bridges, asynchronous transfer mode (ATM) switches, and network switches. Layer 2 devices respond to service requests from network layer (layer 3) devices and issues service requests to physical layer (layer 1) devices. Protocols employed by layer 2 include, but are not limited to Ethernet, Wi-Fi, token ring, frame-relay, point-to-point (PPP) protocol, high-level data link control (HDLC), and advanced data communication control procedures (ADCCP). These protocols are used to provide PPP and point-to-multipoint transmission of data frames that contain error control information.

Layer 3, the network layer, provides functional and procedural processes to transfer variable length data sequences from a source to a destination via one or more networks while maintaining a quality of service (QoS) requested by the transport layer (layer 4). Layer 3 devices perform network routing, flow control, segmentation/desegmentation, and/or various error control functions. Messages having logical addresses and/or names are translated by layer 3 into physical addresses. Layer 3 further determines routes from the message source device to the message destination device(s) in view of traffic problems, such as switching, routing, and/or data packet congestion. Persons of ordinary skill in the art will appreciate that layer 3 devices include, but are not limited to, routers, and Internet protocol (IP) switches. Protocols employed by layer 3 include, but are not limited to IP, IPv6, IP security, Internet control message protocol (ICMP), Internet group multicast protocol (IGMP), and/or datagram delivery protocol (DDP).

In the illustrated example, the PAC manager 104 accesses any network (108, 110) of a communication carrier on a periodic and/or aperiodic basis, in which the network (108, 110) has various level 2 (112) and/or level 3 (114) devices. The level 2 (112) and level 3 (114) devices of a network typically define a network edge, such that a communication carrier may block and/or restrict unauthorized access into the network at that edge. However, persons of ordinary skill in the art will appreciate that the communication carrier may provide authentication servers at the network edge to allow controlled access to the network and/or the layer 2 and layer 3 devices. While such server placement is expensive, the servers allow an interested service provider to query, for example, a database of the communication carrier containing network performance metrics.

As discussed above, performance metrics may be published by a communication carrier to entice and/or otherwise lure service providers to use their network(s). Unfortunately, published metrics may not be up-to-date and/or accurate, or may be biased in a misleading manner. Furthermore, a service provider may consume a great amount of time requesting performance metrics from a plurality of communication carriers, for example, by making authentication requests to access the communication carrier's database(s) of performance data. The service provider may be required to enter a received username and/or password (thereby consuming additional time) so that the authentication server(s) of the communication carrier will allow access to the privileged performance metric data.

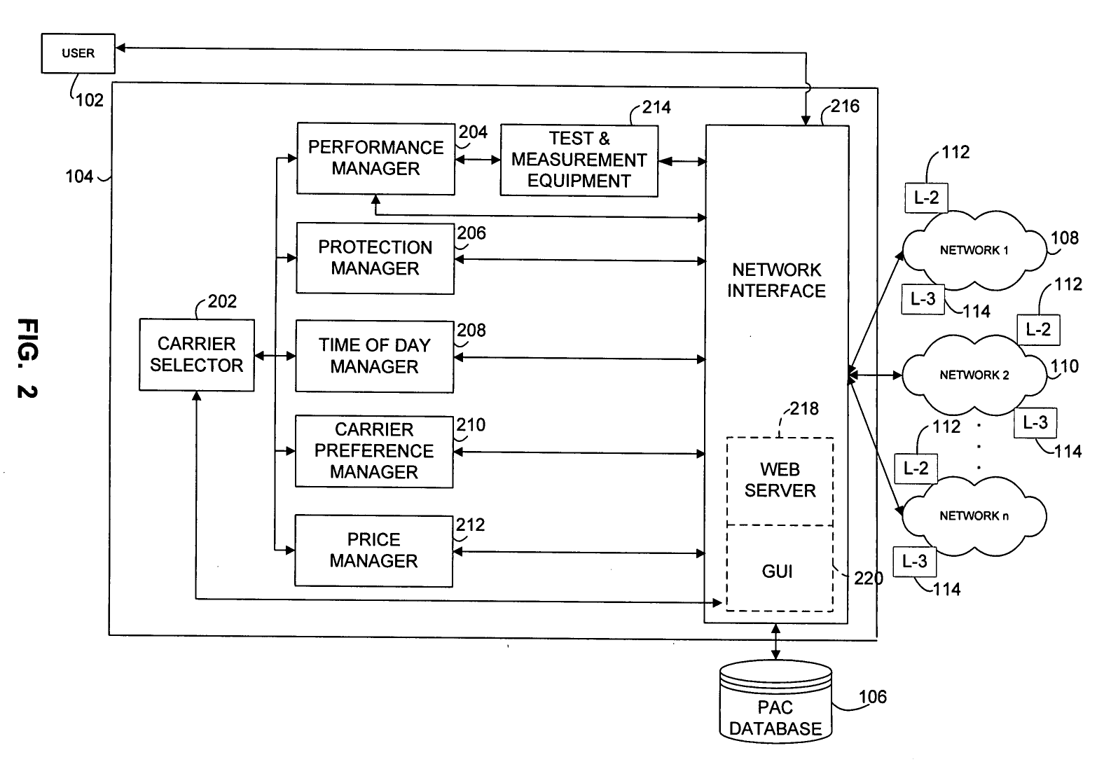

An example PAC manager 104 is shown in FIG. 2. The example PAC manager 104 includes a carrier selector 202, a performance manager 204, a protection manager 206, a time-of-day (TOD) manager 208, a carrier preference manager 210, and a price manager 212. The example PAC manager 104 also includes test and measurement (T&M) equipment 214 to perform empirical tests on the performance of communication networks. T&M equipment 214 may include, but is not limited to, oscilloscopes, spectrum analyzers, network analyzers, logic analyzers, protocol analyzers/exercisers, bit error ratio (BER) testers, and/or signal generators. Such T&M equipment 214 may analyze any communication medium, including wire-based communications (e.g., cable, fiber-optic) and wireless communications (e.g., radio frequency), such as cellular, Bluetooth®, and/or 802.11 wireless technologies. Each of the performance manager 204, the protection manager 206, the TOD manager 208, the carrier preference manager 210, the price manager 212, and/or the T&M equipment 214 may operate on a periodic and/or aperiodic basis to collect and rank metric data for one or more communication carriers, as discussed in further detail below. The carrier selector 202 may receive only the highest ranking metrics from each of the aforementioned managers when selecting a communication carrier.

In the illustrated example, the user(s) 102 accesses the carrier selector 202 and/or various managers (e.g., performance manager 204, protection manager 206, TOD manager 208, carrier preference manager 210, price manager 212) via a network interface 216. User interaction and/or access to the PAC manager 104 may be accomplished via the Internet/intranet, and/or computer, workstation, kiosk, etc. The network interface 216 may enable communication via web-pages via a web server 218 and/or graphical and/or command-line user interfaces via one or more graphical user interfaces (GUIs) generated by a GUI module 220. Each of the aforementioned managers, including the carrier selector 202, interact with the network interface 216 to provide an interface for user/manager interoperability and to receive and process inputs related to determining capabilities of communication carrier networks 108, 110.

The PAC manager 104 of the illustrated example permits a user(s) to manage activities related to communication carrier selection. The network interface 216, for example, is connected to the Internet and has direct access to layer 2 (112) and layer 3 (114) devices of various communication carriers. Rather than penetrate beyond the layer 2 (112) and/or layer 3 (114) devices of any particular communication carrier's network (112, 114), the network interface 216 extracts published carrier performance metrics placed on such devices. Accordingly, the communication carrier is not required to provide expensive authentication hardware devices (e.g., authentication computers and/or servers) at the network edge, and the service provider is not required to interact with such authentication devices (e.g., entering authentication credentials) to obtain carrier performance data.

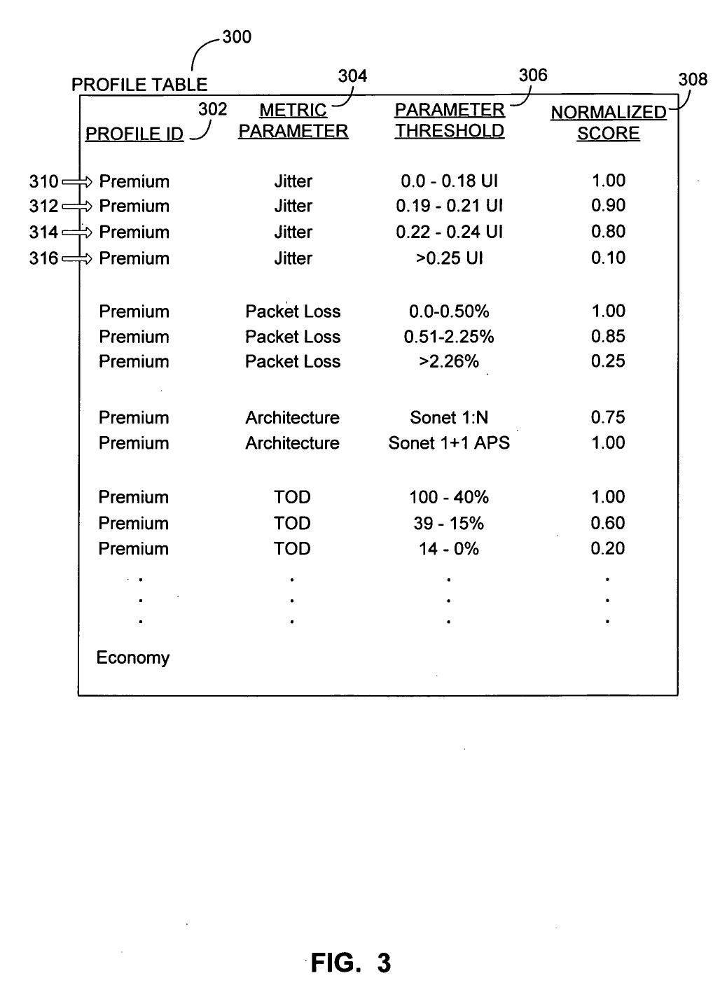

As discussed above, carrier selection may be based upon performance capabilities, protection mechanisms/procedures, TOD bandwidth capabilities, preferences, and/or price information. Service providers may find some of the above example carrier capabilities more or less important based on the needs of their subscribers. Accordingly, the service providers may design and use a profile that favors communication carriers meeting and/or exceeding target capability metric parameters. FIG. 3 illustrates an example profile table 300 that allows a service provider to configure metric parameter thresholds in view of subscriber expectations, demands, and/or needs. The example profile table 300 of FIG. 3 includes a profile identification (ID) column 302 that identifies a unique profile type. The user(s) may label such profile IDs 302 with easy to remember pneumonics, such as “premium,” which may suggest that only carriers with the very best performance capabilities should be considered in the selection process. Alternatively, a service provider may configure a profile and label it “economy,” which may suggest the end-users to be serviced by the carrier to be selected are more concerned with price than performance. Persons of ordinary skill in the art will appreciate that any profile nomenclature may be employed.

While any communication carrier may place their performance information on the network edge for a service provider and/or subscriber to retrieve, each carrier may implement varying types of metric parameters. In view of this carrier performance metric diversity, the profile table 300 of FIG. 3 provides a mechanism by which a service provider and/or subscriber can normalize the disparate carrier metric information before determining/selecting the best communication carrier.

To this end, the profile table 300 of the illustrated example includes a metric parameter column 304 that identifies a metric-type for any corresponding profile ID 302. A parameter threshold column 306 further identifies specific pass/no-pass parameters for the corresponding metric in column 304. A normalized score column 308 assigns a corresponding value to the threshold range(s) in the corresponding row of the table. While the normalized scores of the normalized score column 308 are shown to have values between zero and one, persons of ordinary skill in the art will appreciate that a user (e.g., service provider) may implement any numeric range and/or pass/fail criteria for the normalized score. Generally speaking, in the example of FIG. 3, higher values for the normalized score reflect a greater importance for that particular threshold.

In the illustrated example, four discrete parameter threshold bands for the metric parameter of jitter have been configured to reflect a relative importance of jitter to the service provider. A first row 310 illustrates that the profile “premium” includes a jitter parameter threshold between zero and 0.18 unit intervals (UIs), and that range has been assigned a normalized score of 1.00. A second row 312 illustrates that the profile “premium” also includes a jitter parameter threshold of 0.19 UI to 0.21 UI, which has been assigned a normalized score of 0.9. Additionally a third row 314 illustrates that the profile “premium” includes a jitter parameter threshold 0.22 UI to 0.24 UI, which receives a normalized score of 0.8. Finally, a fourth row 316 illustrates that the profile “premium” establishes that any jitter parameter greater than 0.25 UI receives a normalized score of 0.1. The fourth row 316 normalized score is drastically lower than the previous three rows (310, 312, 314), thereby suggesting that users of the “premium” profile have no interest in communication carriers that are unable to control jitter conditions in a manner that impairs various communication services. As discussed in further detail below, the normalized score for one or more metrics is used to calculate a total result score indicative of the service provider's carrier selection choice(s).

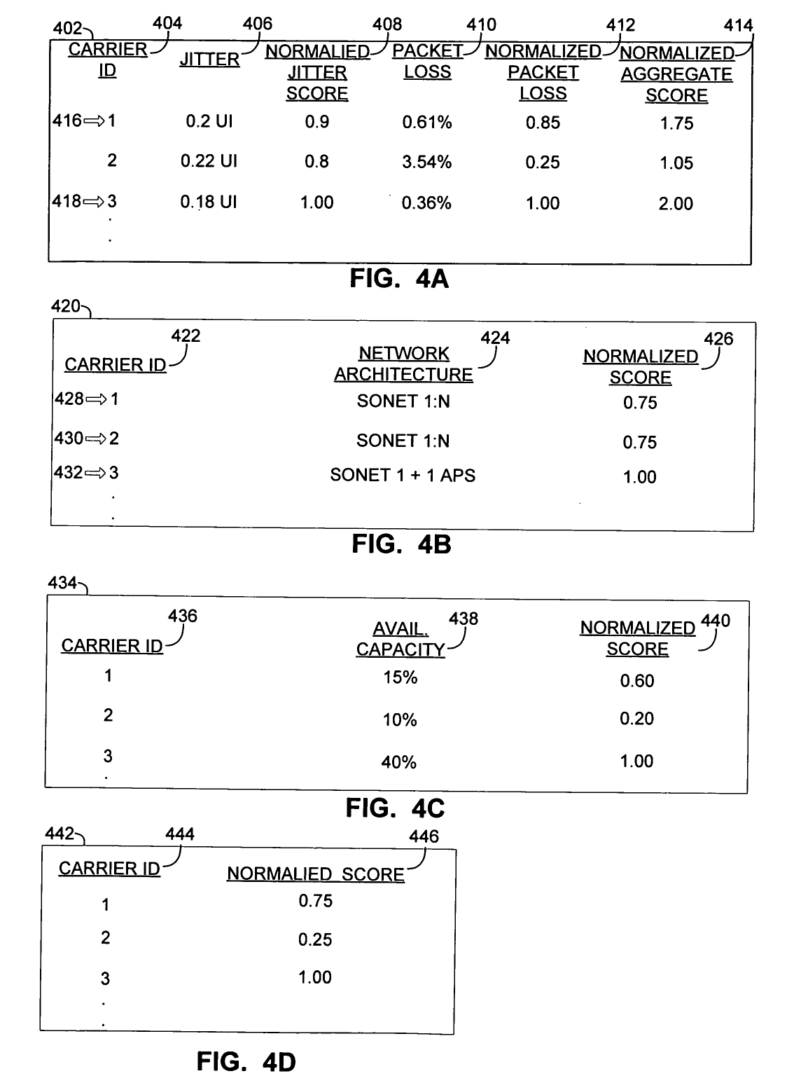

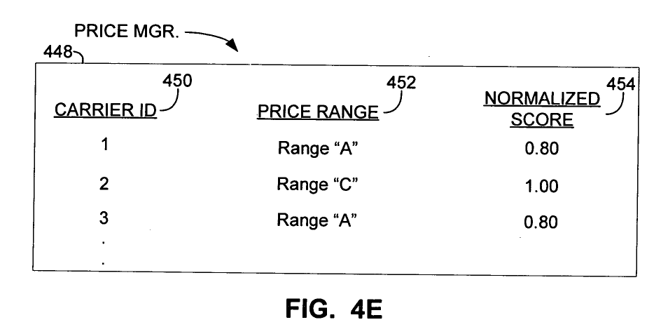

Based on the performance categories and the responses retrieved from the communication carrier(s), each of the managers (e.g., performance manger 204, protection manager 206, TOD manager 208, carrier preference manager 210, price manager 212, etc.) determines a corresponding normalized score for each carrier. For example, FIG. 4A illustrates an example performance table 402 generated and maintained by the example performance manager 204 of FIG. 2. In the illustrated example, the performance table 402 includes a carrier ID column 404 to identify various communication carrier candidates, a jitter column 406 to identify a received jitter metric from the corresponding communication carrier, and a normalized jitter score column 408 to identify a resulting normalized score for the corresponding communication carrier based on the received jitter metric value. The example table 402 also includes a packet loss column 410 to identify a received packet loss metric for the corresponding communication carrier, and a normalized packet loss column 412 to identify a resulting normalized score for the corresponding communication carrier. A normalized aggregate score column 414 identifies a sum total for the normalized scores resulting from the received jitter and packet loss metrics for each corresponding carrier ID. For example, the normalized aggregate score in row 416, which corresponds to communication carrier “1,” lists a value of “1.75,” which is the sum of 0.9 (for the normalized jitter score in column 408) and 0.85 (for the normalized packet loss score in column 412 of FIG. 4A). However, the normalized aggregate score in row 418, which corresponds to communication carrier “3,” lists a value of “2.00” representing the sum of the values in columns 408 and 412 of row 418. The normalized aggregate score column 414 allows rapid identification and sorting of communication carriers having the best qualifications as measured against the example profile table. The carrier IDs having the highest normalized aggregate score are extracted by the carrier selector 202 to calculate an overall best selection, as discussed in further detail below. Persons of ordinary skill in the art will appreciate that the various managers (e.g., the performance manager 204, the protection manager 206, the TOD manager 208, the carrier preference manager 210, and/or the price manager 212) may, instead, forward the metric scores for the highest ranking three carrier IDs.

While the performance table 402 includes rows that combine performance metrics of jitter and packet loss published on the L2 and/or L3 devices of the communication carrier's network, persons of ordinary skill in the art will appreciate that two or more separate sub-tables may be employed to rank two or more performance metrics individually. For example, a separate sub-table for jitter may be maintained and/or ranked by the performance manager 204, and/or a separate sub-table for packet loss may be maintained and/or ranked by the performance manager 204. Without limitation, the performance manager 204 may also receive and/or track any other performance metrics of interest to a service provider. As discussed above, performance metrics may include, but are not limited to latency, crosstalk, signal-to-noise ratio, up-stream/down-stream data rate, and/or signal power level(s). Any of these metrics may be considered individually and/or combined in any manner to form compound metrics.

FIG. 4B illustrates an example protection table 420 generated and maintained by the example protection manager 206 of FIG. 2. In the illustrated example, the protection table 420 includes a carrier ID column 422 to identify various communication carrier candidates, a network architecture column 424 to identify various architecture implementations for respective carriers, and a normalized score column 426 to identify a resulting normalized score for the corresponding carrier based on the implemented protection architecture. In the illustrated example, rows 428 and 430, corresponding to carriers “1” and “2,” respectively. Each of the carriers “1” or “2” implement a Sonet 1:N architecture, which corresponds to a normalized score of “0.75.” However, the highest normalized score of “1.00” is associated with a third carrier “3” in a third row 432. Carrier “3” implements a more robust Sonet 1+1 APS network architecture. Accordingly, the carrier selector 202 may extract only the highest scoring candidates from each manager (204, 206, 208, 210, 212) and/or each corresponding manager table, as shown in FIGS. 4A-4E, as described above.

FIG. 4C illustrates an example TOD table 434 generated and maintained by the example TOD manager 208 of FIG. 2. In the illustrated example, the TOD table 434 includes a carrier ID column 436 to identify various communication carrier candidates, an available day capacity column 438 to identify the carrier's bandwidth capabilities during business hours (e.g., 9:00 AM to 5:00 PM), and a normalized score column 440 to identify a resulting normalized score for the corresponding carrier based on the various TOD capabilities. Persons of ordinary skill in the art will appreciate that alternate and/or multiple TOD periods may be evaluated and/or ranked, based on the needs of the service provider and/or subscribers. For example, additional capacity timeframes for weekdays and/or weekends may be tracked and ranked. In the illustrated example, carrier ID “3” exhibits the highest normalized score because it has the greatest available capacity.

FIG. 4D illustrates an example carrier preference table 442 generated and maintained by the example carrier preference manager 210 of FIG. 2. In the illustrated example, the carrier preference table 442 includes a carrier ID column 444 to identify various communication carrier candidates, and a normalized score column 446 to identify a resulting normalized score for the corresponding carrier. Unlike the other metric-types discussed above, the carrier preference metric may be completely subjective and independent of empirical measurements and/or carrier-provided performance claims. Instead, the carrier preference metric may be set based on general feelings the service provider has regarding the candidate communication carrier, past experiences with the carrier, and/or word-of-mouth regarding the real or perceived capabilities of the carrier. In the illustrated example, carrier “2” of FIG. 4D includes a normalized score of 0.25, which may reflect the service provider's strong dislike for carrier “2.”

FIG. 4E illustrates an example price table 448 generated and maintained by the example price manager 212 of FIG. 2. In the illustrated example, the price table 448 includes a carrier ID column 450 to identify various communication carrier candidates, a price range column 452 to identify a price metric for the corresponding candidates, and a normalized score column 454 to identify a resulting normalized score for the corresponding carrier based on the carrier's price range. Carriers “1” and “3” each list a price range of “A,” which is assigned a corresponding normalized score of “0.80.” Conversely, carrier “2” lists a price range of “C,” which is assigned a corresponding normalized score of “1.00,” and suggests that the service provider and/or subscriber finds price range “C” more desirable than price range “A.” Persons of ordinary skill in the art will appreciate that the price range column 452 may list explicit price values (e.g., dollars per megabyte, cents per transaction, etc.).

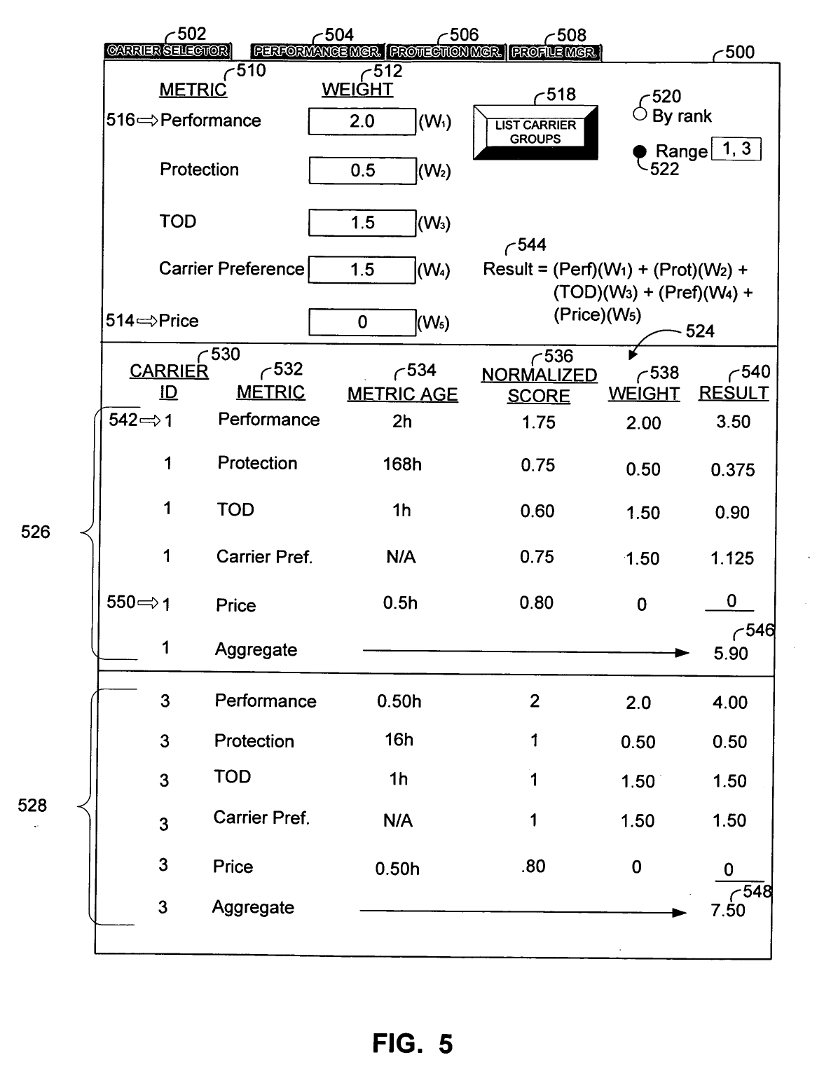

FIG. 5 is an example graphical user interface (GUI) 500 displayed by the web server 218 and/or GUI module 220 of FIG. 2. The illustrated example GUI 500 includes a variety of alternate screen tabs to allow the user to select and/or manage various facets of the example PAC manager 104. In the illustrated example, the GUI 500 includes a carrier selector tab 502 (currently shown), a performance manager tab 504, a protection manager tab 506, and a profile manager tab 508. The example carrier selector tab 502 is selected in FIG. 5 and includes a metric column 510 that identifies known metrics of interest. Additionally, a weight column 512 includes a corresponding numeric entry field for each listed metric in the metric column 510 to allow the user to enter a weight value. For example, the user may enter a small number (e.g., “0”) to indicate that a particular metric, such as a price metric 514, is not considered important. Alternatively, the user may enter a relatively large number (e.g., “2.0”) to indicate that a particular metric, such as a performance metric 516, is very important when making a selection.

After entering one or more values in the weight column 512, a “list carrier groups” button 518 may be selected by the user to access the PAC 104 to utilize the entered weights to generate a list of carriers and corresponding scores. Selecting a rank radio button 520 causes the list of carriers to be presented to the user based on the highest result first, and the lowest result last. On the other hand, selecting range radio button 522 causes the list of carriers to be presented to the user based on specific carrier identities in a user-specified order. In the illustrated example, the range radio button 522 has been selected, and a list 524 with “carrier 1” 526 listed first, and “carrier 3” 528 listed second has been generated. Persons of ordinary skill in the art will appreciate that the range radio button 522 and corresponding list 524 may accommodate any number of carrier groups, and that the list may be navigated by the user via a scroll bar and/or page-turn buttons (not shown).

The example list 524 shown in FIG. 5 includes a carrier ID column 530, a metric column 532, a metric age column 534, a normalized score column 536, a weight column 538, and a result column 540. Each row for any particular carrier group, such as the group “carrier 1” 526 and the group “carrier 3” 528, displays a corresponding value for each metric. As described above, a relatively high weight value suggests that the user places greater importance on a particular metric. As such, a performance row 542 illustrates that the weight of “2.00” (taken from the corresponding user entry in column 512) is multiplied by the normalized score of “1.75” to yield a resulting score of “3.50.” On the other hand, a price row 550 illustrates a weight of “0,” thereby suggesting that price is of no concern when selecting an optimum carrier.

Briefly returning to FIG. 4A, row 416 illustrates that the normalized aggregate score of the jitter and packet loss values for the corresponding carrier is 1.75. Similarly, the normalized score for carrier 1 is shown in FIG. 4E as a value of “0.8,” which is incorporated into the formula 544 of FIG. 5, as shown in row 550. However, because the user has entered “0” as a weight value 514 for the price category, any normalized score that corresponds to the price will have no effect on the sum calculated by the formula 544. The normalized aggregate scores of any particular metric for each carrier are incorporated into the formula 544 by the example carrier selector 202. Accordingly, if the user decides that any particular metric becomes more or less important, the user may modify the weights 512 prior to generating the list 524 of carrier candidates.

In the illustrated example, “carrier 1” 526 has an aggregate score result of “5.90” 546. Similarly, “carrier 3” 528 has an aggregate score result of “7.50” 548. Persons of ordinary skill in the art will appreciate that a carrier with the highest score will reflect a closer match to the user's preferences (weights) than a carrier with a lower score.

While the example carrier selector GUI 500 illustrates a metric age column 534 to inform the user of how old the published carrier data is, persons of ordinary skill in the art will appreciate that the metric age may be incorporated into the formula 544 as an additional metric parameter when making a carrier selection. If the age of the published metric is particularly old, then the user (e.g., service provider) may question whether or not the particular published metric is still accurate. Older metrics may also indicate that the carrier is not proactively monitoring and/or improving various aspects of network performance. Additionally, persons of ordinary skill in the art will appreciate that the weights may include negative numbers, thereby causing the resulting formula 544 score to decrease in value rather than increase.

While the carrier selector tab 502 GUI 500 illustrates an interactive screen for the user and/or service provider, the carrier selector 202 may also be configured to operate automatically. For example, the service provider may configure the PAC manager 104 to periodically search various carrier networks for published metric information. Accordingly, the service provider may configure the PAC manager 104 to automatically select the highest ranking carrier based on, for example, applying the “premium” profile (see FIG. 3) to the received metric information.

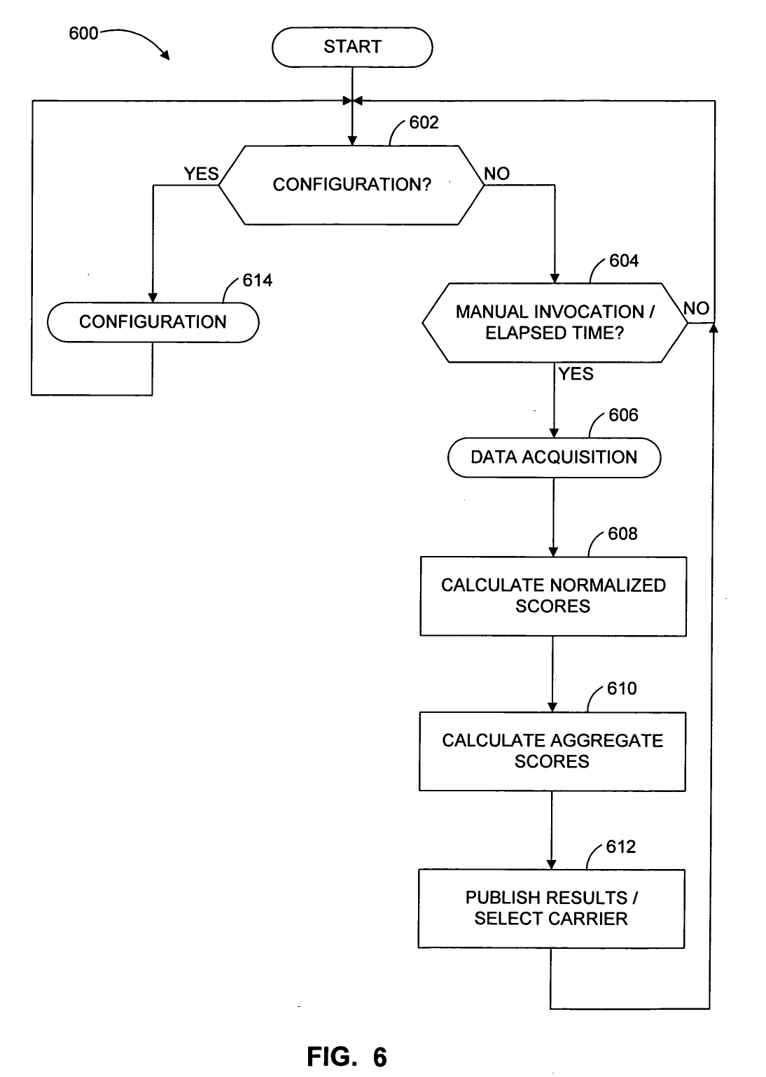

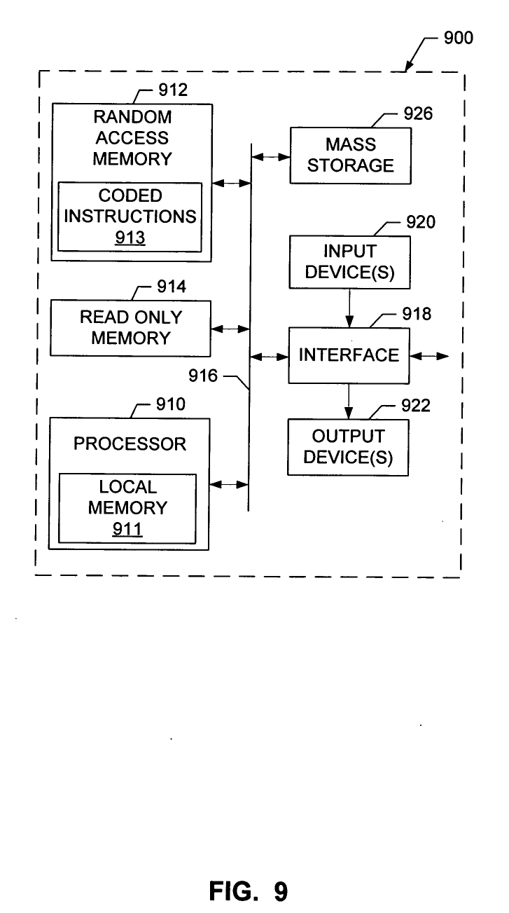

Flowcharts representative of example machine readable instructions for implementing disclosed example methods and apparatus for path acceptance criteria are shown in FIGS. 6-8. In this example, the machine readable instructions comprise a program for execution by: (a) a processor such as the processor 910 shown in FIG. 9, which may be part of a computer, (b) a controller, and/or (c) any other suitable processing device. The program may be embodied in software stored on a tangible medium such as, for example, a flash memory, a CD-ROM, a floppy disk, a hard drive, a digital versatile disk (DVD), or a memory associated with the processor 910, but persons of ordinary skill in the art will readily appreciate that the entire program and/or parts thereof could alternatively be executed by a device other than the processor 910 and/or embodied in firmware or dedicated hardware in a well known manner. For example, any or all of the example PAC system 100, the PAC manager 104, the PAC database 106, the carrier selector 202, the performance manager 204, the protection manager 206, the time of day manager 208, the carrier preference manager 210, the price manager 212, the network interface 216, the web server 218, and/or the GUI module 220 could be implemented by software, hardware, and/or firmware (e.g., it may be implemented by an application specific integrated circuit (ASIC), a programmable logic device (PLD), a field programmable logic device (FPLD), discrete logic, etc.).

Also, some or all of the machine readable instructions represented by the flowcharts of FIGS. 6-8 may be implemented manually. Further, although the example program is described with reference to the flowcharts illustrated in FIGS. 6-8, persons of ordinary skill in the art will readily appreciate that many other methods of implementing the example machine readable instructions may alternatively be used. For example, the order of execution of the blocks may be changed, and/or some of the blocks described may be changed, substituted, eliminated, or combined.

The process 600 of FIG. 6 begins at block 602 where the PAC manager 104 operates in a configuration mode, or a non-configuration mode. In the illustrated example, if the PAC manager 104 is not in a configuration mode (block 602), then the PAC manager 104 determines whether a manual testing process has been invoked or a periodic timer has elapsed (block 604). If no periodic timer has elapsed, or no predetermined test time (e.g., a specific date and time), or no manual test invocation has been invoked, control loops back to block 602. Otherwise, the PAC manager 104 initiates data acquisition (block 606) discussed in further detail below. Metric data collected from one or more network carrier candidates is saved to the PAC database 106 and/or the PAC manager 104 performs empirical tests on the network carrier candidates to verify that published data is consistent with measured data (block 606). The PAC manager 104 retrieves stored carrier data from the PAC database 106 and calculates normalized scores for each metric (block 608), as discussed above in view of FIGS. 4A-4E. Each of the performance manager 204, protection manager 206, time of day manager 208, carrier preference manager 210, and the price manager 212 maintains a list of respective metrics for each carrier identifier. Prior to each of the aforementioned managers calculating a normalized score, such managers compare the raw metric data against the various thresholds of the profile table 300 (see FIG. 3) to determine the normalized value(s) (block 608).

Aggregate scores are calculated by the carrier selector 202 (block 610) when each of the performance manager 204, protection manager 206, time of day manager 208, carrier preference manager 210, and the price manager 212 have completed their calculations of the normalized values, as shown in the tables of FIGS. 4A through 4E. In particular, each of the normalized scores for a metric are multiplied by the corresponding weight 512 as shown in the formula 544. Such calculated aggregate scores associated with carrier identifiers may be published (block 612) in order of highest rank to lowest rank, lowest rank to highest rank, and/or published in a user-selectable order as shown by the range radio button 522 of FIG. 5. Alternatively, the service provider may have configured the PAC manager 104 to automatically make a carrier candidate selection based on the highest returned aggregate score (block 612). Persons of ordinary skill in the art will appreciate that list(s), table(s), screenshot(s), and/or any other display of carrier identifiers and corresponding aggregate scores may be published by the web server 218 as a web page, thereby allowing intranet and/or Internet access to the calculated information. The process 600 may return to block 602 after results are published and/or a carrier has been automatically selected, and wait for another manual and/or time-based invocation of the data acquisition and analysis process.

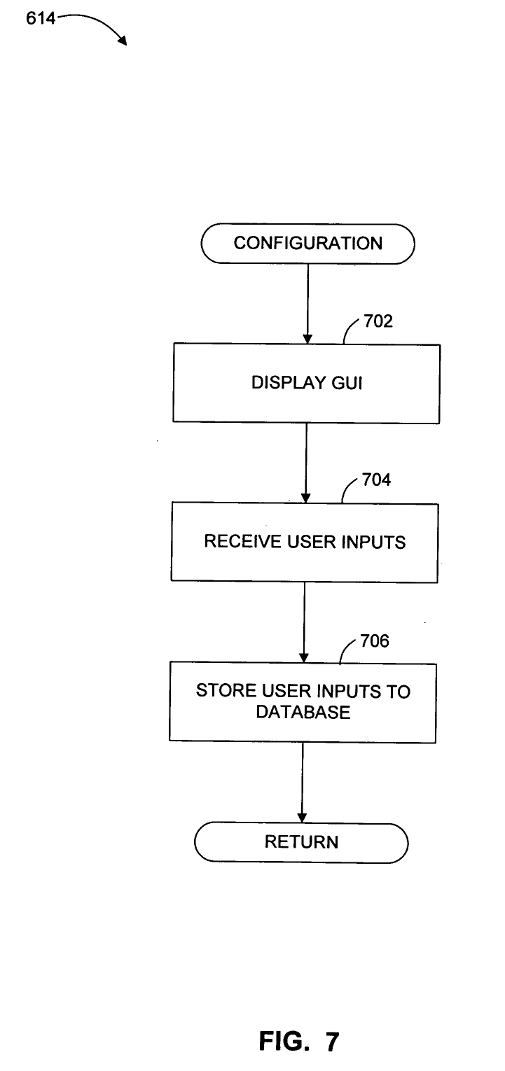

If the PAC manager 104 is in a configuration mode (block 602), then a configuration process begins at block 614. As discussed above, the user is presented with a GUI 500 for PAC manager 104 setup and configuration. The example configuration process 614 of FIG. 7 begins at block 702. The user is presented with the GUI 500, which includes various tabs to configure various facets of the PAC manager 104 including, but not limited to, the carrier selector tab 502, the performance manager tab 504, the protection manager tab 506, and/or the profile manager tab 508. Depending on which GUI sub-screen with which the user interacts, the PAC manager 104 receives the user inputs (block 704).

In the illustrated example of FIG. 5, the GUI 500 displays user input options for the carrier selector tab 502, such as inputs to associate the weight values 512 with the metrics 510. Persons of ordinary skill in the art will appreciate that other tabs may operate in a similar manner. For example, the profile manager tab 508 may present the user with a GUI similar to the profile table 300 shown in FIG. 3. Accordingly, the user may interact with the profile manager GUI to add, delete, and/or edit various profile identifiers (e.g., “premium,” “economy,” etc.) and corresponding threshold ranges to be assigned with a normalized score. In another example, the protection manager tab 506 may present the user with a GUI similar to the protection manager table 420 of FIG. 4B. As such, the user may interact with the protection manager GUI to associate particular normalized scores with particular types of network architecture(s). Any inputs received by the GUIs associated with the carrier selector tab 502 GUI, the performance manager tab 504 GUI, the protection manager tab 506 GUI, and/or the profile manager tab 508 GUI, are stored to the PAC database 106 (block 706).

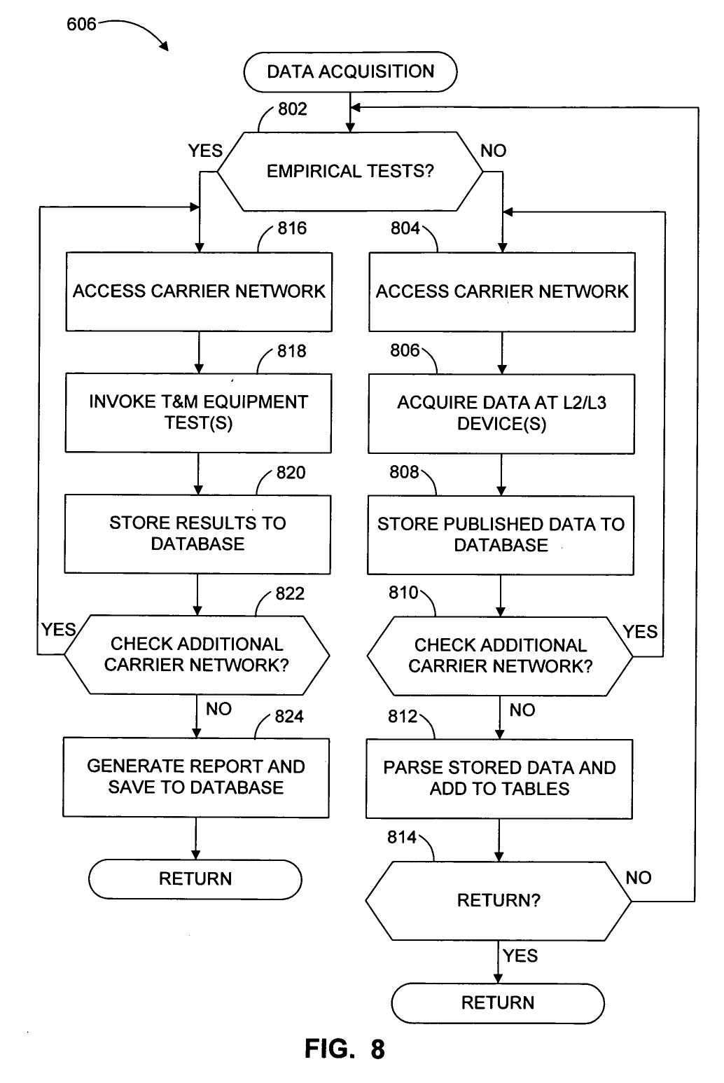

Returning to FIG. 6, if the PAC manager 104 enters a data acquisition process (block 606), the PAC manager 104 determines whether any empirical tests should be performed (block 802), as shown in FIG. 8. If not, the PAC manager 104 attempts to contact a carrier network (block 804) at the L2 and/or L3 devices of the network edge. The network interface 216 may receive various network addresses from the PAC database 106, such as an Internet Protocol (IP) address assigned to a particular carrier. Any number of network addresses may be stored in the PAC database 106 and retrieved by the network interface when performing a data acquisition process. Network administrators and/or managers of the PAC manager 104 may learn of new carrier network addresses (e.g., new carrier businesses) and store such carrier address data in the PAC database 106 for future queries so that those carriers may be compared with other carriers to determine the best choice for a subscriber base.

The PAC manager 104 obtains carrier data placed on L2 and/or L3 devices of the carrier's network edge(s) (block 806). As discussed above, carriers that publish and store such metrics data (e.g., performance data, protection architecture data, time of day bandwidth trends, price, etc.) may allow service providers quick access to useful information without cumbersome authentication procedures that are typically required to access most carrier networks. Additionally, because the carrier network edge is typically defined by L2 and/or L3 devices, the carrier does not need to invest additional money for authentication servers located at the network edge. The metrics data retrieved by the network interface 216 of the PAC manager 104 is stored in the PAC database 106 for later analysis (block 808). If additional carriers are available and/or known by the PAC manager 104 (block 810), the process may return to block 804 to obtain additional metric data for a different carrier.

If all available and/or known carriers have been accessed, and respective metric data stored in the PAC database 106 (block 810), then the various managers (204, 206, 208, 210, 212) of the PAC manager 104 may parse the stored data in the PAC database 106 for the specific types of metric data relevant to their function (block 812). For example, the performance manager 204 accesses the PAC database 106 and parses the retrieved data for metrics related to, but not limited to, jitter, packet loss, latency, transmission rate(s), etc. The relevant metrics are extracted by the performance manager 204 and arranged in a performance table, such as the example performance table 402 as shown in FIG. 4A. Similarly, the protection manager 206 accesses the PAC database 106 and parses the retrieved data for metrics related to network architecture protection mechanisms including, but not limited to, Sonet 1:N, Sonet 1+1 APS, unidirectional path switched ring configurations, bi-directional line switching ring configurations, and/or multi-protocol label switching configurations. Persons of ordinary skill in the art will appreciate that the time of day manager 208, the carrier preference manager 210, and/or the price manager 212 operates in a similar fashion. Namely, parsing the retrieved data for predetermined data of interest and populating that data in the corresponding database.

When the data acquisition process 606 is complete (block 814), then control returns to block 608 as shown in FIG. 6. However, if the PAC manager 104 is configured to perform empirical tests, then control returns to block 802. The empirical tests begin at block 816, in which the network interface 216 of the PAC manager 104 accesses a carrier network, as discussed above. The PAC manager 104 invokes the test and measurement (T&M) equipment 214 (block 818) to initiate tests to collect actual metric data including, but not limited to, network bit rate(s), power level(s), jitter, delay, bit error rate(s) (BER), BER eye diagram(s), signal-to-noise ratios, etc. Persons of ordinary skill in the art will appreciate that testing with the T&M equipment 214 may include functional testing, load testing, load generators, and/or regression testers. Such testing may include IP traffic generation and receivers utilizing any protocols, such as TCP and/or UDP so that, for example, round trip time information may be determined. Additionally, the T&M equipment 214 may generate impairments, such as latency, delay, jitter, limited bandwidth, and/or lost packets, to determine how well the carrier can respond. For example, carriers that employ deep buffers may handle latency, delay, and jitter issues much better, thereby allowing a higher quality service to potential subscribers. Carriers with shallow buffers, on the other hand, may subject the potential subscribers to lower quality voice and/or data services (e.g., echoes).

Data retrieved by the T&M equipment 214 is saved to the PAC database 106 for analysis (block 820). If there are additional carriers available for empirical testing (block 822), control returns to block 816. Otherwise, the collected empirical data is compared to the metric data published by the carriers and a report is generated (block 824) for review by a network administrator, service provider, or any other user of the PAC manager 104. The generated report may illustrate that the carrier(s) are publishing accurate metric performance data, thereby increasing a level of trust. On the other hand, the generated report may illustrate that the carrier(s) are publishing metric performance data that is inconsistent with the empirical data measured by the T&M equipment 214. The service provider may share the observed disparity between the empirical data and the carrier's published metric data with the carrier to offer the carrier an opportunity to explain the inconsistency (e.g., recent storm damage).

FIG. 9 is a block diagram of an example computer 900 capable of executing the example machine readable instructions represented by the flowcharts of FIGS. 6-8 to implement the apparatus and methods disclosed herein. The computer 900 can be, for example, a server, a personal computer, a laptop, a PDA, or any other type of computing device.

The computer 900 of the instant example includes a processor 910 such as a general purpose programmable processor. The processor 910 includes a local memory 911, and executes coded instructions 913 present in the local memory 911 and/or in another memory device. The processor 910 may execute, among other things, the example processes illustrated in FIGS. 6-8. The processor 910 may be any type of processing unit, such as a microprocessor from the Intel® Centrino® family of microprocessors, the Intel® Pentium® family of microprocessors, the Intel® Itanium® family of microprocessors, the Intel XScale® family of processors, and/or the Motorola® family of processors. Of course, other processors from other families are also appropriate.

The processor 910 is in communication with a main memory including a volatile memory 912 and a non-volatile memory 914 via a bus 916. The volatile memory 912 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 914 may be implemented by flash memory and/or any other desired type of memory device. Access to the main memory 912, 914 is typically controlled by a memory controller (not shown) in a conventional manner.

The computer 900 also includes a conventional interface circuit 918. The interface circuit 918 may be implemented by any type of well known interface standard, such as an Ethernet interface, a universal serial bus (USB), and/or a third generation input/output (3GIO) interface.

One or more input devices 920 are connected to the interface circuit 918. The input device(s) 920 permit a user to enter data and commands into the processor 910. The input device(s) can be implemented by, for example, a keyboard, a mouse, a touchscreen, a track-pad, a trackball, isopoint and/or a voice recognition system.

One or more output devices 922 are also connected to the interface circuit 918. The output devices 922 can be implemented, for example, by display devices (e.g., a liquid crystal display, a cathode ray tube display (CRT), a printer and/or speakers). The interface circuit 918, thus, typically includes a graphics driver card.

The interface circuit 918 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 900 also includes one or more mass storage devices 926 for storing software and data. Examples of such mass storage devices 926 include floppy disk drives, hard drive disks, compact disk drives and digital versatile disk (DVD) drives. The mass storage device 926 may implement the PAC database 106.

At least some of the above described example methods and/or apparatus are implemented by one or more software and/or firmware programs running on a computer processor. However, dedicated hardware implementations including, but not limited to, application specific integrated circuits, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a magnetic disk or tape); a magneto-optical or optical medium such as an optical disk; or a solid state medium such as a memory card or other package that houses one or more read-only (non-volatile) memories, random access memories, or other re-writable (volatile) memories; or a signal containing computer instructions. A digital file attached to e-mail or other information archive or set of archives is considered a distribution medium equivalent to a tangible storage medium. Accordingly, the example software and/or firmware described herein can be stored on a tangible storage medium or distribution medium such as those described above or successor storage media.

To the extent the above specification describes example components and functions with reference to particular standards and protocols, it is understood that the scope of this patent is not limited to such standards and protocols. For instance, each of the standards for Internet and other packet switched network transmission (e.g., Transmission Control Protocol (TCP)/Internet Protocol (IP), User Datagram Protocol (UDP)/IP, HyperText Markup Language (HTML), HyperText Transfer Protocol (HTTP)) represent examples of the current state of the art. Such standards are periodically superseded by faster or more efficient equivalents having the same general purpose. Accordingly, replacement standards and protocols having the same general purpose are equivalents to the structure/protocols mentioned herein, which are contemplated by this patent and are intended to be included within the scope of the accompanying claims.

This patent contemplates examples wherein a device is associated with one or more machine readable mediums containing instructions, or receives and executes instructions from a propagated signal so that, for example, when connected to a network environment, the device can send or receive voice, video or data, and communicate over the network using the instructions. Such a device can be implemented by any electronic device that provides voice, video and/or data communication, such as a telephone, a cordless telephone, a mobile phone, a cellular telephone, a Personal Digital Assistant (PDA), a set-top box, a computer, and/or a server.

Additionally, although this patent discloses example software or firmware executed on hardware and/or stored in a memory, it should be noted that such software or firmware is merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the above specification described example methods and articles of manufacture, persons of ordinary skill in the art will readily appreciate that the examples are not the only way to implement such methods and articles of manufacture. Therefore, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method to determine capabilities of a communication carrier comprising:
transmitting a metric information request to at least one of a layer two open standards interconnect (OSI) device or a layer three OSI device, the at least one layer two or layer three OSI device storing metric information indicative of carrier capabilities; and
receiving the metric information from the at least one layer two or layer three OSI device.

2. A method as defined in claim 1 wherein the at least one of the layer two or layer three OSI devices is not a carrier access server.

3. A method as defined in claim 1 wherein the at least one layer two or layer three device transmits the metric information in response to receiving the metric information request.

4. A method as defined in claim 1 wherein the metric information identifies an age of the metric information.

5. A method as defined in claim 1 further comprising calculating a carrier score for the communication carrier based on the received metric information and based on a profile representative of preferences.

6. A method as defined in claim 5 further comprising normalizing the received metric information before calculating the carrier score.

7. A method as defined in claim 5 further comprising automatically selecting the carrier based on the calculated carrier score.

8. A method as defined in claim 7 wherein the selection is based on at least one of a score threshold or a carrier score rank.

9. A method as defined in claim 5 wherein the profile identifies at least one of a performance criterion, a protection criterion, a time-of-day criterion, a carrier preference criterion, a price criterion, or a metric information age criterion.

10. A method as defined in claim 9 wherein the performance criterion comprises at least one of jitter, bit-error-rate (BER), latency, packet loss, packet delivery rate, or compliance with service level agreements (SLAs).

11. A method as defined in claim 9 wherein the protection criterion comprises at least one of network architecture, expected outage times, failure convergence time, or vendor equipment.

12. A method as defined in claim 9 wherein the time-of-day criterion comprises bandwidth capabilities at a plurality of times.

13. A method as defined in claim 9 wherein calculating the carrier score comprises assigning a weight to each of the at least one of the performance criterion, the protection criterion, the time-of-day criterion, the carrier preference criterion, the price criterion, or the metric information age criterion.

14. A method as defined in claim 9 further comprising a plurality of profiles, each of the plurality of profiles comprising a plurality of parameter thresholds.

15. A method as defined in claim 14 wherein each of the plurality of parameter thresholds comprises a corresponding normalization value.

16. An apparatus comprising:
a network interface to acquire a plurality of metric information for at least one of a plurality of communication carriers, the plurality of metric information stored on at least one of a layer two open standards interconnect (OSI) device or a layer three OSI device; and
a carrier selector to calculate respective scores for the at least one of the plurality of communication carriers based on the acquired plurality of metric information.

17. An apparatus as defined in claim 16, further comprising a performance manager to calculate a normalized score for a first portion of the acquired metric information, the first portion of the acquired information being indicative of at least one of jitter, packet loss, delay, crosstalk, data rate, signal-to-noise ratio (SNR), or power level.

18. An apparatus as defined in claim 17, wherein the performance manager further comprises test and measurement equipment to measure at least of one of jitter, packet loss, delay, crosstalk, data rate, SNR, or power level.

19. An apparatus as defined in claim 16, further comprising a protection manager to calculate a normalized score for a first portion of the acquired metric information, the first portion of the acquired information being indicative of at least one of a SONET network architecture, a unidirectional path switched ring, a bidirectional line switched ring, a 1:N switching architecture, a 1+1 automatic protection switching architecture, or a multi protocol label switching recovery architecture.

20. An apparatus as defined in claim 16, further comprising a time-of-day manager to calculate a normalized score for a first portion of the acquired metric information, the first portion of the acquired information being indicative of time-based bandwidth capabilities.

21. An apparatus as defined in claim 16, further comprising a carrier preference manager to calculate a normalized score for a first portion of the acquired metric information, the first portion being indicative of a carrier identifier.

22. An apparatus as defined in claim 16, further comprising a price manager to calculate a normalized score for a first portion of the acquired metric information, the first portion being indicative of carrier cost.

23. An apparatus as defined in claim 16 further comprising a predetermined profile, the scores calculated based on the acquired plurality of metric information and the predetermined profile.

24. An article of manufacture storing machine readable instructions which, when executed, cause a machine to:
transmit a metric information request to at least one of a layer two open standards interconnect (OSI) device or a layer three OSI device, the at least one layer two or layer three OSI device storing metric information indicative of carrier capabilities; and
receive the metric information from the at least one layer two or layer three OSI device.

25-36. (canceled)
